(19) United States
(12) Patent Application Publication
(10) Pub. No.: US 2005/0242287 A1
(43) Pub. Date: Nov. 3, 2005

(54) Optical terahertz generator / receiver

(76) Inventor: Hosain Hakimi, Watertown, MA (US)

Correspondence Address: HOSAIN HAKIMI, 199 COOLIDGE AVE. #201, WATERTOWN, MA, 02472, US

(21) Appl. No.: 11/085,309

(22) Filed: Mar. 21, 2005

Related U.S. Application Data
(60) Provisional application No. 60/566,351, filed on Apr. 30, 2004.

(51) Int. Cl. G01T 1/161

(52) U.S. Cl. 250/363.09

(57) ABSTRACT

A method for the high power generation and detection of terahertz radiation is presented. It comprises of an optical waveguide with a core, and a mostly hollow cladding or terahertz wave transparent material surrounding the core. The cladding region is a terahertz waveguide. A pump light source is coupled to the core to promote nonlinear optical process, such as Raman scattering, in the core which in turn leads to terahertz radiation being emanated or received through fiber cladding.

### CROSS-REFERENCE TO RELATED APPLICATION

This patent application claims the benefit of provisional patent application Ser. No. 60/566,351 filed 2004 Apr. 30.

### FEDERALLY SPONSORED RESEARCH

Not applicable

### SEQUENCE LISTING OR PROGRAM

Not applicable

### BACKGROUND OF THE INVENTION

The invention generally relates to the generation of a coherent optical source having its center frequency in the terahertz (i.e., far infrared) band. More particularly, the present invention relates generally to generation and detection of terahertz radiation using stimulated process such as Raman scattering (SRS) in an optical waveguide such as a fiber.

Terahertz (THz) radiations or T-rays represent the last bastions of relatively unexplored electromagnetic spectrum. Residing somewhere between microwave and infrared, T-rays could have frequencies anywhere from 0.1 to 20 THz. What makes T-rays special is the potential application of this radiation in many military, security, commercial, biomedical, pharmaceutical and, scientific research. Among the prospective benefits, better detection of concealed weapons, hidden explosives and land mines; improved medical imaging and more productive study of cell dynamics and genes; real-time “fingerprinting” of chemical and biological terror materials in envelopes, packages or air; better characterization of semiconductors; and widening the frequency bands available for wireless communication. On medical front it has been shown T-rays can be used as a far superior tool for early detection of breast lumps compared with today mammogram examinations. T-rays also can penetrate skin tissues for early detection of skin cancer before the actual appearance of the legions on the skin. Using powerful tomography algorithm T-rays can map a 3-D image of human body with much higher resolution than Nuclear Magnetic Resonance (NMR) for early detection of diseases throughout the body. Terahertz imaging could reveal interesting features of the many materials with distinct absorptive and dispersive properties in this spectral range, which corresponds revealingly with bio-molecular vibrations.

Within the next decade, x-ray imaging systems will be replaced by imaging systems using terahertz frequency sources and detectors in areas such as medical, security and quality control applications. T-rays can penetrate most solid substance like x-rays. In contrast to x-rays, T-rays are non-ionizing, and thus are non-lethal and safer for imaging applications. Further, T-ray systems produce true high resolution images rather than shadowy images produced by x-ray systems.

A heavy demand for terahertz technology also exists in the communications industry. Development of components necessary for a terahertz frequency heterodyne receiver will result in a dramatic increase in the available bandwidth in wavelength-division-multiplexed communications networks.

However, while the benefits of having T-rays have been established for over a decade, having a compact, powerful and, coherent source of T-ray has eluded technologist so far. Needless to say whichever applications may ultimately materialize, many will require high-average-power broadband or narrowband tunable terahertz light sources. Currently, there are two basic methods for generating terahertz (THz) beams: First, using photoconductors and second, using nonlinear optical frequency conversion techniques. In the photoconductive approach, electrically biased high-speed photoconductors are used as transient current sources for radiating antennas. These include dipoles, resonant dipoles, transmission lines, tapered antennas, and large-aperture photoconducting antennas. See for example a paper by Shuji Matsuura et al. “Generation of coherent terahertz radiation by photomixing in dipole photoconductive antennas”, Appl. Phys. Lett. 70(5), pp. 559, 3 February 1997. In the nonlinear optical frequency conversion approach, second-order or higher-order nonlinear optical effects in unbiased materials are used. See for example, U.S. Pat. Nos. 6144679,6697186, and 5543960.

Optical rectification by far is the most important of these nonlinear optics techniques. The optical rectification method requires no electrical bias and thus is simpler than the photoconductive approach. In this method, the nonlinear material is illuminated with ultrashort laser pulses of order of fs, causing a time-dependent polarization to be created in the material by way of the electro-optic effect. This induced polarization is proportional to the intensity of the excitation pulse, and produces radiation of electromagnetic waves having a terahertz bandwidth. With a suitable electro-optic material, the amplitude of the resulting terahertz field is controlled by the intensity of the optical excitation beam. In turn, this intensity is a result of the pulsewidth, energy, and spot size of the beam. The problem with this method is that at high optical intensities, the efficiency of the rectification mechanism may decrease due to competing nonlinear effects. The incident optical intensity at which these competing mechanisms will occur is material dependent.

It has to be noted here that no matter which techniques is chosen the average terahertz power generated usually resides on order of microwatts even with many watts of average input pump power. These low powers obviously limit potential use of THz wave in many applications. In addition, most if not all the mentioned schemes require cryogenic cooling which further limits their use in commercial applications. In a recent paper by Carr et al. of Jefferson Lab a record average power level of 20 watts for terahertz pulses has been reported. Yet again, it has to be noted, the generated terahertz power is over a broad band and extracting monochromatic bands out of this still results in low powers. Further, the generated terahertz waves are by negative charge electrons achieving relativistic velocity via large and long electron linear accelerators. Such linear accelerators use large cryogenically cooled superconducting magnets. Moreover, the effect of coherent emission on the electron beam could result in a self-amplified instability, resulting in large pulse-to-pulse variations, thereby limiting the potential application of this technique. Therefore it is not very likely that this type of technology be reducible to commercially viable devices in foreseeable future.

The present invention has numerous advantages over the prior art which can easily lead to commercial and military utilization. First the size of the present invention is small compare to aforementioned methods since there is no need for an electron linear accelerator or an ultra-short pulse source such as Ti-Sapphire laser. Second the generated terahertz average power may reside in hundreds of milli-watts as compared to microwatts for equivalent input pump powers. Third the entire radiation may easily be collected or focused due to its high temporal and spatial fidelity. Fourth the present invention can achieve broadband or tunable narrowband operation depending upon mode of operation. Fifth, in fiber versions of the invention, the radiation may be directly guided to remote and hard to reach areas. Sixth, with the present invention, there is no need for any cryogenic cooling schemes. Finally, the present invention may be used as a high speed terahertz receiver with bandwidth measured in many of GHz, limited only by its associated electronic components.

### SUMMARY OF THE INVENTION

It is accordingly a primary object of the present invention to provide a method and means of generating a high power wideband or narrowband coherent radiation in a terahertz region of the electromagnetic spectrum. It is also object of the present invention to provide a method and means of detecting radiation in a terahertz region of the electromagnetic spectrum.

The applicant provides a terahertz generator/detector by utilizing optical nonlinear process such as Stimulated Raman Scattering (SRS) in an optical waveguide. Another possible nonlinear process to generate terahertz radiation is self phase modulation (SPM). Elementary excitations (for example phonons, polaritons, excitons, magnons, etc.) may be present in any waveguide core medium. The core may be made of soft glass such as phosphate or silicate, fused silica, fused silica doped with P, fused silica doped with semiconductor nano-crystals such as Si, GaAs, and CdSe. The Waveguide may also be a semiconductor such as GaAs, InP or multi quantum wells. Continuous Wave (CW) or pulsed pump light with frequency ωpump impinges upon such medium experience Raman spontaneous scattering and it is manifested as sidebands in its spectrum. In thermal equilibrium only lower frequency sideband ωs called stokes field is prominent. The Sidebands are shifted frequency photons generated by refractive index of the medium being modulated by optical phonons with vibration frequency ωtera. The frequency range of the vibrations (the width of the ωs sideband, Δωs, or equivalently the width of the Raman spectra) depends on the materials and doping concentrations and can be engineered to reside anywhere in 0.1 to 20 THz. For instance, with light elements (Boron, Lithium) vibration frequencies are in 0-20 THz region, intermediate elements (Rare earths, Ti, V, Mn, Cu) in 5-10 THz region, while heavy elements (Pb, Bi, W, Au, OS) in a few THz territory. As the intensity of the impinge pump light is allowed to increases, the power of the stoke frequency ωs grows with it and their difference or beat frequency [ωpump−ωs] can further drive the molecular oscillation coherently at frequency ωtera=[ωpump−ωs]. This in turn modulate the refractive index more strongly and reinforces the sideband frequency power even further which leads to what is known as Raman gain or Stimulated Raman Scattering (SRS) process. In polar media, a media consist of both positive and negative ions, the resulting increase in amplitude of phonon-polariton oscillations gained through SRS process generates radiation at terahertz frequency ωtera (similar to classical radiating dipole antenna). This terahertz generation indeed may occur in any optical waveguide with polar medium such as a fused silica or a GaAs semiconductor during SRS process. However, the generated radiation may quickly be reabsorbed if surrounding medium, for example the cladding, is not transparent to terahertz radiation. This is indeed the case for a conventional communication grade optical fiber for instance. It is the result of this re-absorption process that terahertz radiation is not generally observed in output of optical fibers or waveguides.

Therefore, it is the object of this invention to provide a waveguide that its cladding is substantially transparent to terahertz radiation or devoid of materials to prevent terahertz re-absorption. Alternatively we can think of the cladding region as a waveguide itself for transport of terahertz radiation. To avoid confusion, we refer to the core as an optical waveguide while the cladding would be referred as a terahertz waveguide.

One such optical waveguide is an air-clad fiber with a cow-web cladding structure. In this design the cladding is largely hollow or filled with air, thus transparent to terahertz wave, and the core is made with polar medium with high level of nonlinearity such as fused silica or soft glass to promote high degree of SRS. The core location could be centered or off-centered respect to mostly terahertz transparent cladding region. Any generated terahertz radiation mode from the core gains power as it travels along the core and would become bound and “gain guided” with its spatial extent emanating from the core into mostly hollow or terahertz transparent cladding. The materials surrounding the cladding may be made of polymers such as polyethylene to be transparent to waves in terahertz region. In this case the terahertz generated mode may be “index guided” as well as gain guided. Alternatively, the surface materials surrounding the cladding may be made to reflect waves in terahertz region for instance with metallic coatings. In this case the generated terahertz radiation mode would be “reflection guided” as well as gain guided. The terahertz radiation would then exit the fiber cladding at output end, the terahertz waveguide region. The typical length of mentioned fiber may be in neighborhood of few 100 meters to achieve good SRS. The core to cladding diameter ratio of such a fiber is proportional to ratio of optical to terahertz wavelengths.

Alternatively, a semiconductor optical waveguide may consist of a core surrounded by a nearly hollow or terahertz transparent cladding region with typical length of 10's of millimeters, due to 1000-10000 greater non linearity and thus SRS magnitude. The materials surrounding the cladding may be made of polymers such as polyethylene to be transparent to waves in terahertz region. Alternatively, the surface materials surrounding the cladding may be made to reflect waves in terahertz region for instance with metallic coatings. Other options for core of the semiconductor waveguide are III-V semiconductors (such as GaAs, InP, InGaAs, InGaAsP, etc.) or II-VI semiconductors (such as CdS, CdSe, etc.) and multi quantum well structures made from III-V and II-VI semiconductor systems.

Another structure of interest is a Polarization Maintaining (PM) waveguide. The fiber version may be realized for instance by an oval shape core for linear polarization maintaining. This allows only linear polarization mode to form provided pump light is also linearly polarized and it is coupled to either fast or slow axis of the oval shape core. In this case the generated terahertz radiation emanating from the hollow cladding is also linearly polarized. Alternatively a circularly polarization maintaining fiber type is also possible if the fiber pre-form is spun as the core is drawn during manufacturing process. The generated terahertz wave in this case is circularly polarized provided pump light is also circularly polarized as it is coupled to the fiber core.

The two types of waveguide or fiber discussed above can also be made with more than one core such as a multi core structure. Each core may have the same or different materials each with different dopants embedded in them. Additionally, each core may have pump light with identical or different wavelengths resulting in single or multi-frequency terahertz radiation. The advantage of multi core structure is first, to increase the output power of the generated terahertz radiation and second, to increase the emitted bandwidth of the generated terahertz emanating from largely hollow cladding. This is important when an ultra wideband high power terahertz radiator is desired.

To generate a narrow band monochromatic coherent terahertz radiation a second light source such as a laser, in addition to the pump source, may be coupled to the core from the same or opposite end of the waveguide. The frequency of this source may be selected to coincide with frequency ωs of generated shifted photons and may be tuned under the Raman gain spectra. The reason for narrowband tendency in this case stems from the fact that only shifted photons at specific frequency ωs, residing within Δωs width, are allowed to gain power by robbing more energy from the pumping light. As a result, the shifted photons with pre-select frequency ωs grow in intensity and lead to stronger pre-select beat frequency ωtera=[ωpump−ωs] which in turn drives the oscillating dipoles at frequency ωtera more forcefully to radiate narrow band higher power terahertz wave. Indeed this embodiment that radiates narrow band coherent terahertz wave may be interpreted as a terahertz fiber or waveguide laser. Another advantage of using the second optical source is to make the invention a tunable terahertz generator. By tuning or shifting the frequency of the second source ωs under the Raman gain spectral width Δωs, the resulting beat frequency, ωtera, also changes and forces the center of generated terahertz frequency to shift accordingly.

Another way to generate a narrow band terahertz generation without the need for the second optical source is by a pair of Waveguide Bragg Gratings (WBG), one close to the input and other close at the output, along the core of the waveguide types discussed above. Such WBG can be imprinted or written directly in the core using well established techniques such as using appropriate phase masks and illuminating it with ultraviolet laser light. The center reflection frequency band of the grating is set at ωs, the frequency of stokes shifted photons in the medium. The reason for narrowband tendency in this case stems from the fact that only shifted photons at specific frequency ωs, residing within Δωs width, are allowed to reflected back and forth in the fiber core and robbing more energy from the pumping light. As a result, the shifted photons with pre-select frequency ωs grow in intensity and lead to stronger beat frequency ωtera which in turn drives the oscillating dipoles at pre-select frequency ωtera more forcefully to radiate narrow band higher power terahertz wave. Another advantage of adding WBG pair is to make the invention a tunable terahertz generator. By tuning or shifting the frequency of the pumping source, ωpump, or tuning the center frequency of the WBG, the resulting beat frequency, ωtera=[ωpump−ωs], also changes and forces the center frequency of generated terahertz to shift accordingly.

The technique my also provide a multiple frequency line terahertz generator. If the intensity of the Raman shifted photons at frequency ωs=[ωpump−ωtera] becomes high enough, a secondary Raman process starts with generation of photons of frequency ωs−ωtera=[ωpump−2 ωtera] and accompanying coherent phonons. This secondary Raman process may be reinforced by addition of more pair of gratings at fiber ends as described above with center reflection frequency band of [ωpump−2 ωtera]. Therefore, a second pair of WBG, again one grating close to input and the other close to output end of the fiber or waveguide, may be placed along the core to promote the generation of secondary sidebands in the SRS spectrum. In general N pairs of gratings may be added with reflection band frequency set at [ωpump−N×ωtera] resulting in many sidebands but with frequency difference of ωtera between them. The beat frequency among any two adjacent sidebands would drive the oscillating dipoles with frequency ωtera to generate radiation in terahertz. The technique to generate multiple frequency line by SRS process by placing appropriate pairs of WBG is known as “Cascaded Raman” in the literature. See for example a paper by M. Dianov, et al, “Three-cascaded 1407-nm Raman laser based on phosphorus-doped silica fiber”, Optics Letters/Vol. 25, No. 6/pp. 402, Mar. 15, 2000. Therefore we have utilized the Cascaded Raman scheme in our favor to generate multiple frequency line terahertz radiation.

Yet as mentioned previously, it is another goal of this invention to provide a method and means for detection of terahertz radiation. The basic waveguide or fiber structure that has just been discussed for generation of terahertz wave may be used in reverse, for detection of such waves.

Again we assume the waveguide cladding is mostly hollow or made of material that is largely transparent to terahertz radiation. If waveguide or fiber core is being optically pumped, either co- or counter-propagating to the direction of incoming terahertz wave, some power is converted to frequency ωs. As incoming terahertz radiation at frequency ωtera is collected and focused into the hollow cladding, a portion of the wave is absorbed by oscillating dipoles of the core medium. Absorption causes the amplitude of oscillating dipoles to grow which in turn leads to modulation of the index of refraction of the material and leads to an increase in stokes component power. The increase in power of the sideband frequency ωs may be then used as a measure of terahertz wave presence. Due to sub-picosecond response of dipoles in core media, the detection scheme may be capable of ultra high speed operation with bandwidth of several terahertz.

For practical considerations for reception, it is desirable to have a terahertz detection device with its intake free from any obstruction such as a pumping light source. It is therefore beneficial to have the pump light and incoming terahertz waves coupled in opposite side of the hollow waveguide. Therefore, one end of the waveguide may be utilized as intake to receive terahertz wave while the opposite end may be used for core pumping. On the pump side, we can use a wavelength division multiplexer (WDM) coupler to divert the shifted ωs photons to a power monitoring port. This power monitoring port may include an optical band-pass filter with centered band-pass frequency of ωs and an optical power meter (a low speed optical to electrical converter) or a high speed receiver for data receptions. In order to improve pump conversion efficiency, one may place a waveguide Bragg Grating (WBG) close to waveguide intake end, with center reflection frequency of ωpump. The pump light is then allowed to travel the length of the waveguide twice for more efficient pump conversion. Furthermore by addition of second Bragg Grating at the same intake end (next to first WBG) with center reflection frequency of ωs, one can collect more shifted photons hence improving the terahertz detection. This is due to recycling of stokes shifted photons at frequency ωs toward the WDM coupler and re-routing it to the receiver. However this improvement in detection efficiency may be accomplished at the expense of terahertz bandwidth response caused by round trip time delay of reflected stokes shifted photons.

### BRIEF DESCRIPTION OF THE DRAWINGS

Other objects, features, and advantages of the invention will be apparent from the following description taken together with the drawings in which:

FIG. 1 illustrates a basic wideband terahertz generator waveguide.

FIGS. 2a through 2j depict various preferable core/cladding structures of the terahertz generator waveguide.

FIG. 3 illustrates a narrowband tunable terahertz generator with addition of a second optical light source to embodiment of FIG. 1.

FIG. 4 depicts another possible narrowband terahertz generator waveguide utilizing a pair of WBG to embodiment of FIG. 1.

FIG. 5 shows the terahertz generator waveguide with addition of a second pair of WBG to embodiment of FIG. 4 for multiple frequency coherent terahertz generation.

FIG. 6 shows a multi-core terahertz generator waveguide structure utilizing incoherent pumping scheme.

FIG. 7 illustrates a multi-core terahertz generator waveguide structure utilizing coherent pumping scheme.

FIG. 8 shows a basic wideband terahertz wave receiver waveguide.

FIG. 9 illustrates a terahertz wave receiver waveguide with reduced pumping threshold as compared to FIG. 8 receiver.

FIG. 10 shows a terahertz wave receiver waveguide with enhanced terahertz detection as compared to FIG. 8 receiver.

FIG. 11 depicts a terahertz wave receiver waveguide with simultaneous reduced pumping threshold and enhanced detection as compared to FIG. 8 receiver.

### DESCRIPTION OF THE PREFERRED EMBODIMENTS

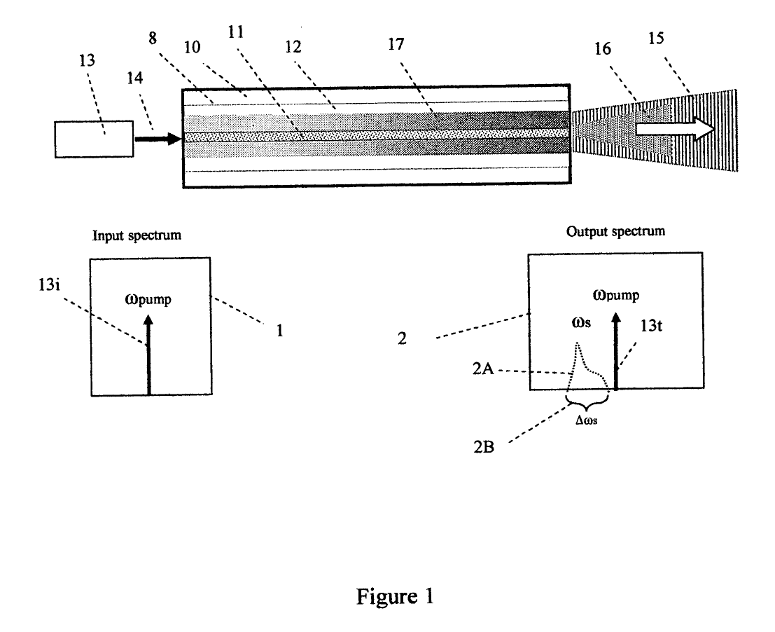

FIG. 1 constitutes the most basic terahertz wave generator. In FIG. 1, core 11 is an optical waveguide surrounded by a terahertz waveguide 12, a substantially hollow cladding or terahertz transparent region. In addition, the cladding 12 may be surrounded by substantially terahertz transparent material 10. The surface 8 surrounding cladding 12 may be reflective or transparent to terahertz radiation. Pump source 13 provides optical pumping to core 11 through optical connection 14. Source 13 may be a laser. Further, source 13 may be a tunable laser source. Optical connection 14 may be an optical fiber with a core size compatible with core 11 for optimum coupling efficiency. Alternatively connection 14 may represent a free space focused light coupled into core 11 from pump source 13. The shading 17 represent the increase in generated terahertz wave as light from source 13 is being converted to stokes shifted photons by the core medium 11. Light 16 emerging from the core 11 includes the unconverted portion of the pump light 13 and generated stokes component. Insert 1 illustrates the spectrum of the pump light 13 at input as 13i before being coupled to core 11 through connection 14. Insert 2 shows the output light spectrum 16 exiting core 11. The spectrum at output reveals the unconverted portion of the pump light as 13t and stokes component or stimulated Raman gain spectra 2A with its associated spectral width 2B. Radiation 15 represents the generated wideband terahertz wave dictated by spectral width 2B emerging from the substantially hollow or transparent cladding 12, the terahertz waveguide output.

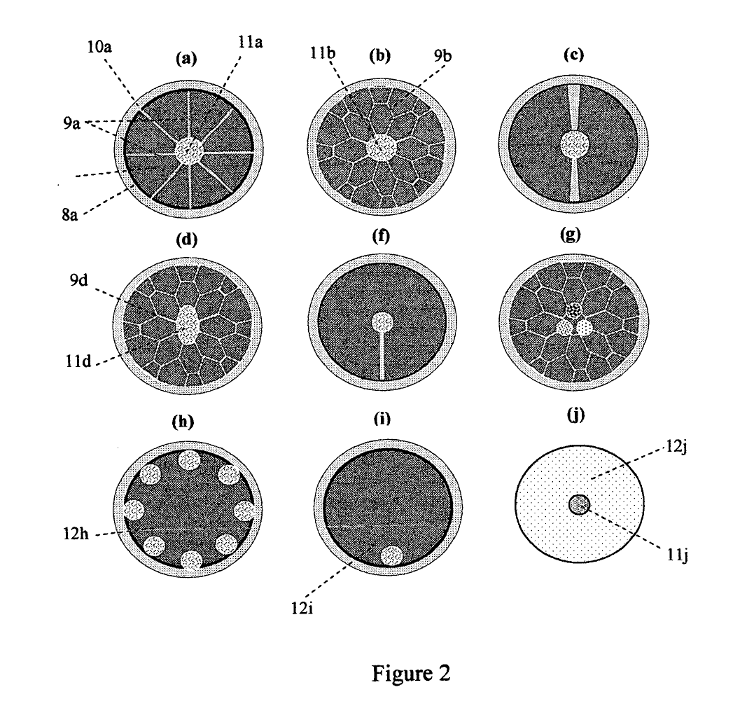

FIG. 2 illustrates a cut away cross sectional view of several preferred core/cladding geometries of the waveguide. Without loss of generality, and in order to avoid clutter, not all figures have been numbered. FIG. 2a shows core 11a, the optical waveguide, at the center surrounded by mostly hollow cladding or terahertz transparent 12a, the terahertz waveguide. The region 10a may be made of dielectric material that is transparent to terahertz radiation or the surface 8a that surrounds the cladding 12a may be coated to reflect terahertz radiation. Core 11a may be supported in a hollow cladding 12a structure by terahertz transparent support membranes 9a. The total number or shape of supports is immaterial as long as they hold the core 11a in the cladding 12a successfully. For instance, in FIG. 2a eight supports, FIG. 2c two, and FIG. 2f only one support is shown. In FIGS. 2b and 2d the supports 9b and 9d holding cores 11b and 11d respectively, has a cow-web shape. FIG. 2d shows core 11d with an oval shape to promote polarization maintaining operation. FIGS. 2g and 2h show a multi core structure of the present invention. FIG. 2g shows three close-to-center cores while FIG. 2h shows eight off-centered cores. In FIGS. 2h and 2i there are no supports for the off-centered cores since they are positioned on the rim surfaces of the cladding 12h and 12i respectively. FIG. 2j illustrates a special case where the core is only surrounded by cladding 12j. Cladding 12j is not hollow but made of substantially terahertz transparent media. Here the cladding 12j captures most of the terahertz wave.

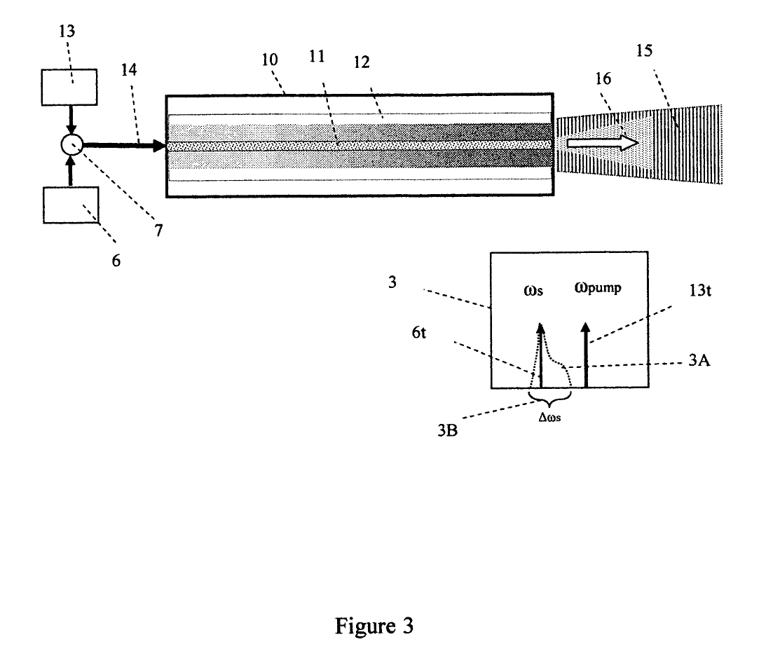

FIG. 3 depicts the embodiment of the FIG. 1 but with addition of a second light source 6. Light source 6 may be a laser and further it may be tunable. Source 6 and pump 13 are both coupled to core 11 through coupler 7 and optical connection 14. Coupler 7 may be a fiber-optic or a free space combiner. In this scheme 50% of light from each source namely 13 and 6 are lost. To avoid this loss, coupler 7 may be a fiber-optic or free space wavelength division multiplexer (WDM) to combine both sources 13 and 6 together without much loss. Insert 3 shows the output spectrum of the light 16 exiting the core 11. The spectrum reveals the unconverted portion of the pump light as 13t and generated stokes component or stimulated Raman gain spectra 3A. Radiation 15 represents the generated narrowband coherent terahertz wave emerging from the mostly hollow or transparent cladding 12 output at frequency ωtera. As the center frequency of the source 6 depicted in insert 3 as 6t (or center frequency of pump light 13) is varied within the spectral width 3B the center frequency of the generated terahertz wave 15 is also changes according to ωtera=[ωpump−ωs]. Therefore this embodiment is a tunable narrowband terahertz generator.

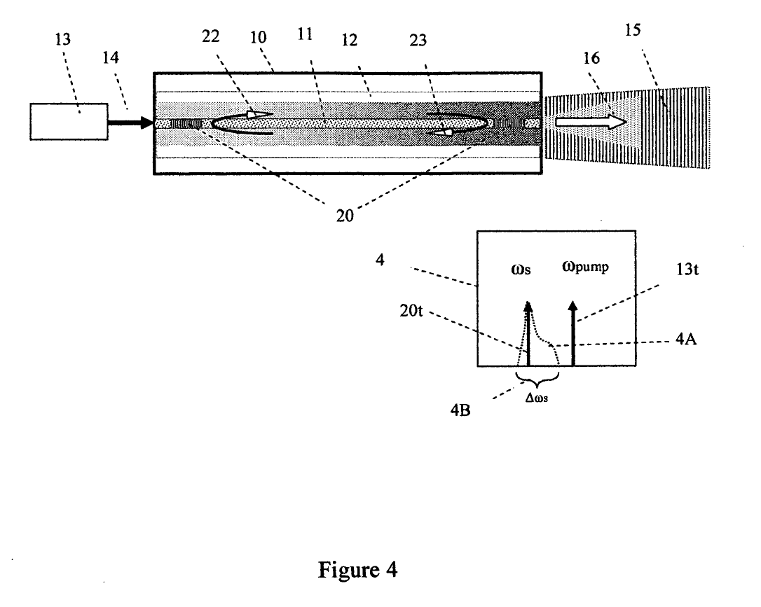

FIG. 4 illustrates another embodiment of the present invention. A pair of WBG 20 with center reflection frequency of ωs has been added close to intake and outtake of core 11 of FIG. 1 respectively. The shifted photons are then allowed to re-circulate in the core 11 as indicated by arrows 22 and 23. Insert 4 shows the output spectrum of the light 16 exiting the core 11. The spectrum reveals the unconverted portion of the pump light as 13t, stokes component or stimulated Raman gain spectra 4A, Raman gain spectral width 4B, and center reflection frequency 20t of the WBG pair 20. Radiation 15 represents the generated narrowband coherent terahertz wave emerging from the mostly hollow or transparent cladding 12 output at frequency ωtera. As the center frequency of the pump source 13 (or center reflection frequency of WBG pair 20) is varied, the center frequency of the generated terahertz wave 15 is also changes according to ωtera=[ωpump−ωs]. The degree of tuning is dictated by the Raman gain width 4B. Therefore this embodiment is also a tunable narrowband terahertz generator.

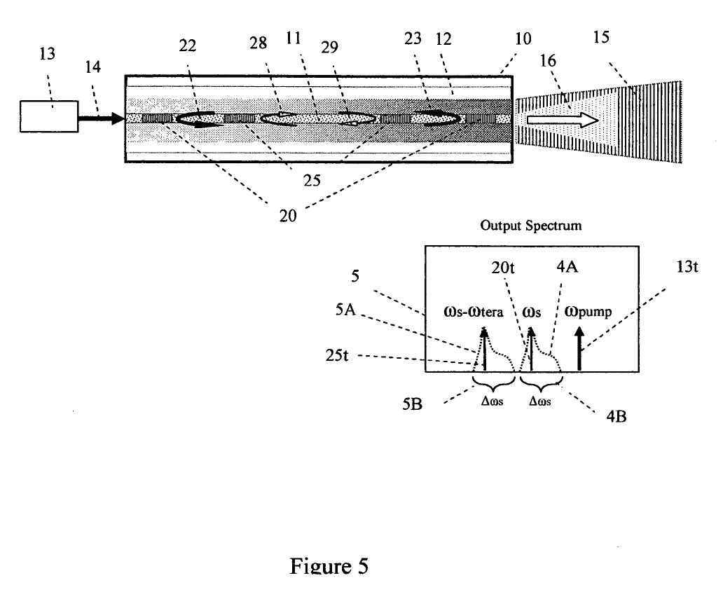

FIG. 5 shows a second pair of gratings 25 has been added to embodiment previously depicted in FIG. 4. The center reflection frequency of the new WBG pair 25 is set at [ωs−ωtera]. Insert 5 shows the output spectrum of the light exiting core 11. As it is clear the secondary stokes component 5A with its spectral width 5B is also present as compared with insert 4. The arrows 28 and 29 indicate the second order generated shifted photons 25t at frequency [ωs−ωtera] are allowed to re-circulate in core 11. This promotes a coherent multiple narrowband frequency terahertz operation of ωtera and 2ωtera. Radiation 15 represents the generated terahertz wave emerging from the mostly hollow or terahertz transparent cladding 12 at waveguide output. As the center frequency of the pump source 13 (or center reflection frequency of WBG pair 20 or 25) is varied the center frequency of the generated terahertz wave 15 is also changes. Again the degree of tuning is dictated by the spectral width 5B (or 4B). Therefore this embodiment is a tunable multi frequency line coherent terahertz generator.

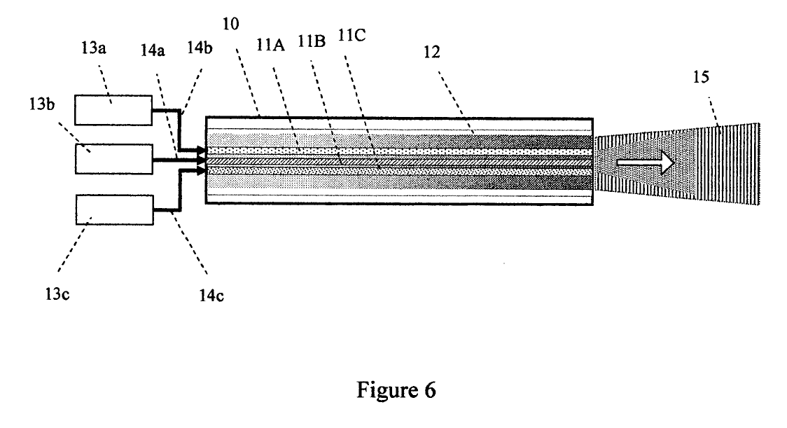

FIG. 6 shows a multi-core embodiment of the present invention. Fiber or waveguide 10 is shown with three cores 11A, 11B and 11C. Each core is being optically pumped with three different laser sources 13a, 13b and 13c through connections 14a, 14b and 14c. Again 14a, 14b and 14c may represent fiber to core 11A, 11B and 11C connections respectively. Alternatively 14a, 14b and 14c may represent free space focused lights from sources 13a, 13b and 13c being coupled to cores 11A, 11B and 11C respectively. The pump sources 13a, 13b and 13c may have the same or be tuned at different frequency. In this embodiment the terahertz generated wave contribution from each core 11A, 11B and 11C can add up incoherently. This arrangement is an example of incoherent pumping. Although not shown in the FIG. 6 each core 11A, 11B and 11C may have pair of WBG, close to intake and outtake, as it was discussed in FIGS. 4 and 5 for single or multi line frequency terahertz generation. Radiation 15 represents the generated terahertz wave emerging from the mostly hollow cladding 12 output.

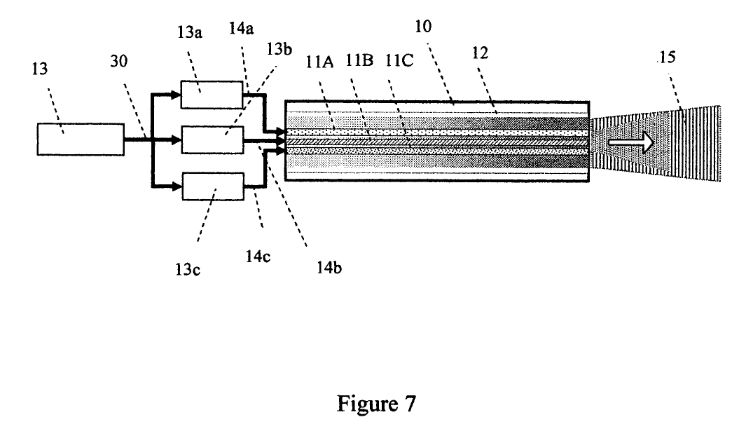

FIG. 7 shows a multi-core structure with pump sources that are coherently locked in frequency respect to each other. In this embodiment the terahertz generated wave contribution from each core 11A, 11B and 11C may add up coherently. This is an example of multi-core structure with coherent pumping. The laser light from pump source 13 is being fed to three optical amplifiers 13a, 13b and 13c through splitter 30. Splitter 30 may be a 1×3 fiber-optic splitter/coupler. Although not shown, the splitter 30 may also represent a 1×N splitter/coupler, in case of a multi-core waveguide 10 structure with N cores where N is any integer larger than 1. The light from each amplifier enters the corresponding cores 11A, 11B and 11C through connections 14a, 14b and 14c respectively. The amplifiers could be a semiconductor or fiber type amplifier. Furthermore, to increase the pump power, 13a, 13b and 13c may be double-clad high power fiber amplifiers. Each core 11A, 11B and 11C may have one or more pair of WBG as it was discussed in FIGS. 4 and 5 for single or multi frequency line terahertz generation. Radiation 15 represents the generated terahertz wave emerging from the mostly hollow cladding 12 at output. As the center frequency of the pump source 13 (or center reflection frequency of WBG) is varied the center frequency of the generated terahertz wave 15 is also changes. Therefore this embodiment is a tunable terahertz generator.

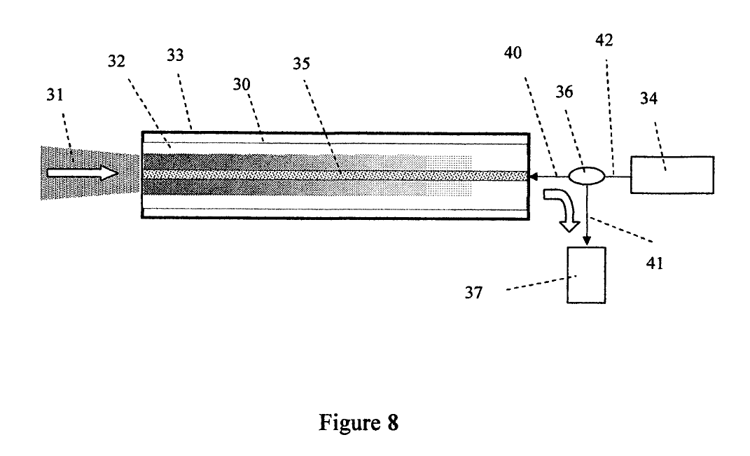

In FIG. 8, Core 35, an optical waveguide, surrounded by a terahertz waveguide 32 that is a substantially hollow cladding or substantially terahertz transparent region constitutes the most basic terahertz receiver. In addition, the cladding 32 may be surrounded by substantially terahertz transparent material 33. The surface 30 surrounding cladding 32 may be reflective or transparent to terahertz radiation. Incoming terahertz radiation 31 that is to be detected is focused at waveguide 33 intake into cladding 32. At waveguide 33 outtake, pump light 34 is coupled to core 35 through connections 42 and 40 of WDM device 36. Pump light 34 may be a laser. Additionally pump 34 may be a fiber pigtailed device with its core size compatible with core 35 for best fiber to waveguide light coupling efficiency. WDM device 36 may be a fiber optic coupler with its fiber core size also compatible to both core 35 and pump source 34 for best coupling efficiency. WDM coupler 36 connects pump light 34 with frequency ωpump through the first port connection 42, to core 35 through its second port, connection 40, while directs any light with center frequency ωs to power meter 37 through its third port, connection 41. Alternatively if pump source 34 is not a fiber pigtailed device then the light from the source can be focused into core 35 through WDM device 36. WDM device in this case may be a bulk optics element such as a fabry-perot or an interference filter. Again the device 36 allows the light from pump source 34 with frequency ωpump to pass through while it reflects any light with frequency ωs to power meter or receiver 37. Receiver 37 is an optical to electrical converter detector. Through SRS process pump 34 causes stokes shifted frequency photons with frequency ωs to be generated which then may propagate in co or counter pump direction respect to pump 34 in core 35. As terahertz radiation 31 propagates inside cladding 32 it is partially absorbed by core 35 which in turn steals more power from the pump 34 and add it to stokes shifted photons with frequency ωs. This causes an increase in power level of stokes shifted photons. This increase is monitored at outtake by power meter 37 through connection 41 as detection or presence of terahertz wave 31.

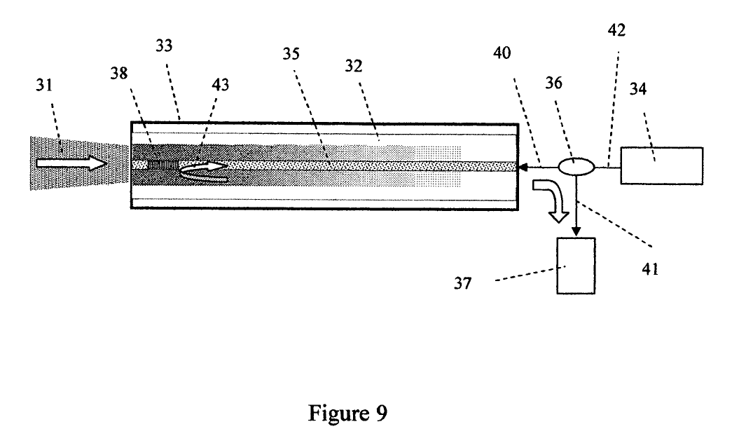

FIG. 9 shows another improved receiver structure of FIG. 8. By placing a WBG 38 with center reflection frequency ωpump in core 35, at waveguide intake, we may re-circulate the pump 34 photons depicted by the arrow 43 for better pumping conversion efficiency. This may reduce the requirement for pumping the core 35 with high power source for SRS generation.

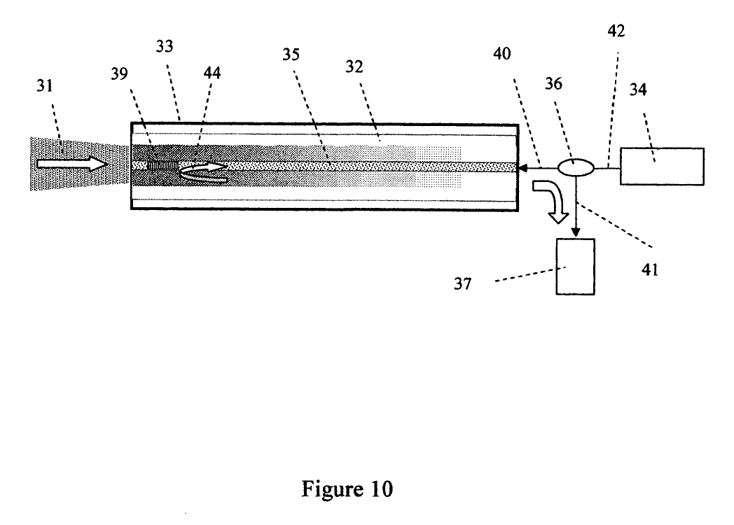

FIG. 10 shows yet another improved receiver structure of FIG. 8. By placing a WBG 39, in core 35, at waveguide intake and with center reflection frequency ωs, the generated co pump propagating stokes shifted photons may also be re-routed back, depicted by the arrow 44, to outtake and to power meter 37 via WDM coupler 36. Therefore both the power of generated co and counter propagating shifted photons with frequency ωs may be detected by power meter 37. This would enhance the terahertz detection threshold.

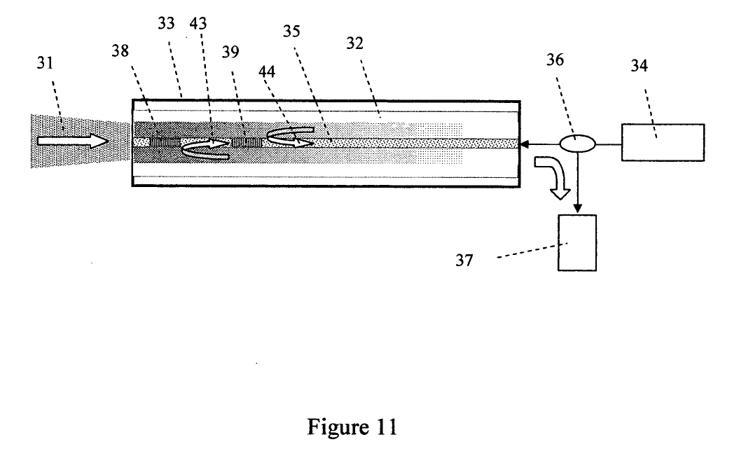

FIG. 11 shows a more improved receiver structure respect to FIG. 10. By placing both the WBG 38 and WBG 39 in core 35, at waveguide intake and with center reflection frequency ωpump and ωs respectively, the generated co pump propagating stokes shifted photons may also be re-routed back, depicted by the arrow 43, to outtake and to power meter 37 via WDM coupler 36. Therefore both the power of generated co and counter propagating shifted photons with frequency ωs may be detected by power meter 37. WBG 39 would enhance the terahertz detection threshold as explained previously for FIG. 10 structure. Further WBG 38 may reduce the requirement for pumping the core 35 with high power source for SRS generation as explained previously for FIG. 9 embodiment.

1. A method for generating and detecting a terahertz band electromagnetic wave using an optical waveguide, comprising of:
at least one core, made of polar media capable of promoting nonlinear optical process, and a substantially none absorbing terahertz wave cladding region surrounding the core(s).

2. The waveguide of claim 1, further comprising of a dielectric material that surrounds the cladding which is substantially transparent to waves in terahertz region

3. The waveguide of claim 2, wherein the dielectric surfaces that surround the cladding may be coated of materials that reflect waves in terahertz region

4. The optical waveguide of claim 1 where the core is fused silica.

5. The waveguide of claim 4, wherein the dopant atoms in the core may be one or combinations of light elements like Li, Be, B, Al, Mg, P, intermediate elements like Ti, V, Mn, Cu, Ag, Cd, In, Ge, heavy elements like, Pb, Bi, Au, W, Os, and rare earth elements like Cerium, Lutetium, neodymium, ytterbium, erbium, praseodymium, and thulium.

6. The optical waveguide of claim 4, wherein the dopant elements in the core are semi-conductor nano-crystals.

7. The optical waveguide of claim 4, where dopants in the core are, Si, InP, InGaAs, GaAs.

8. The optical waveguide of claim 1 where the core may be made of III-V semi-conductors, such as GaAs, InP, InGaAs, InGaAsP, or II-VI semiconductors (such as CdS,

9. The optical waveguide of claim 1 where the core may be made of II-VI semi-conductors, such as CdS, CdSe.

10. The optical waveguide of claim 1 where the core may be made of semiconductor with multi quantum well structures.

11. The optical waveguide of claim 1 where the core is made of soft glass.

12. The optical waveguide of claim 1 wherein the core has a non circular geometry to promote polarization maintaining operation.

13. The optical waveguide of claim 1 wherein the core is offset from the center

14. The optical waveguide of claim 1 further comprising of:
a pump light source that may be tunable in frequency is coupled to core through one end of the waveguide.

15. The optical waveguide of claim 14 wherein the pump source is polarized.

16. The optical waveguide of claim 14 wherein a pair of WBG that may be tunable in their center reflection frequencies has been imprinted in the core, one of the pair close to first end of the waveguide while the second of the pair has been imprinted in the core close to second end of the waveguide.

17. The optical waveguide of claim 16, wherein a second pair of WBG that may be tunable in their center reflection frequencies has been imprinted in the core, one of the pair close to first end of the waveguide while the second of the pair has been imprinted in the core close to second end of the waveguide.

18. The optical waveguide of claim 14, wherein a second optical source that may be tunable in frequency is coupled to the core from the same or opposite end of the waveguide.

19. The optical waveguide of claim 1, wherein the waveguide has more than one core, further comprising of:
a single optical pump source that may be tunable in frequency is coupled through one end of the waveguide to all cores simultaneously.

20. The optical waveguide of claim 1, wherein the waveguide has more than one core, further comprising of:
optical pump sources that may be tunable in frequency are coupled to each core independently.

21. The optical waveguide of claim 1 further comprising:
a pump light source that may be tunable in frequency is coupled to the core, through first and second port of a WDM coupler, and the core at the same end is coupled to an optical to electrical converter detector through third port of the WDM coupler.

22. The optical waveguide of claim 21 further comprising of:
a tunable WBG imprinted in the core close to second end of the waveguide

23. The optical receiver of claim 22, wherein a second tunable WBG may be imprinted in the core close to second end of the waveguide.
